(19) United States
(12) Patent Application Publication
(10) Pub. No.: US 2011/0149837 A1
(43) Pub. Date: Jun. 23, 2011

(54) METHOD FOR MOBILE SATELLITE COMMUNICATION BY COORDINATED MULTI-POINT TRANSMISSION AND APPARATUS THEREOF

(75) Inventors: Hee-Wook KIM, Daejeon (KR); Kunseok KANG, Daejeon (KR); Do-Seob AHN, Daejeon (KR); Ho-Jin LEE, Daejeon (KR)

(73) Assignee: ELECTRONICS AND TELECOMMUNICATIONS RESEARCH INSTITUTE, Daejeon (KR)

(21) Appl. No.: 12/938,522

(22) Filed: Nov. 3, 2010

(30) Foreign Application Priority Data
Dec. 18, 2009 (KR) 10-2009-0127341
Mar. 22, 2010 (KR) 10-2010-0025152

(51) Int. Cl. H04B 7/204

(52) U.S. Cl. 370/319

(57) ABSTRACT

Provided is mobile satellite communication method and apparatus. The satellite communication method includes detecting a location of a terminal, determining a signal transmission scheme for the terminal using the terminal location, determining a subcarrier region to transmit a signal to the terminal using the location of the terminal, and communicating with the terminal using the determined signal transmission scheme and the determined subcarrier region.

### CROSS-REFERENCE(S) TO RELATED APPLICATIONS

The present application claims priority of Korean Patent Application Nos. 10-2009-0127341 and 10-2010-0025152, filed on Dec. 18, 2009, and Mar. 22, 2010, respectively, which are incorporated herein by reference in their entirety.

### BACKGROUND OF THE INVENTION

1. Field of the Invention

Exemplary embodiments of the present invention relate to a method for mobile satellite communication and an apparatus thereof; and, more particularly, to a method for mobile satellite communication by coordinated multi-point transmission and an apparatus thereof.

2. Description of Related Art

In a mobile satellite communication system, major fields to be improved are an overall system capacity and an Effective Isotropic Radiated Powder (EIRP). Further, a large frequency reuse factor has been considered to eliminate interference between adjacent beams when a multi-beam based service is provided. In general, a frequency reuse factor of 3 or 7 has been considered.

Due to the increment of requirements to a high quality multimedia service, a mobile satellite communication system has been required to provide a broadband service. However, a very limited bandwidth has been allocated to a mobile satellite communication service. For example, a bandwidth of about 30 MHz is allocated for a satellite IMT-2000 according to ITU-R. Here, IMT-2000 stands for International Mobile Telecommunication-200 and ITU-R stands for International Telecommunication Union Radiocommunication sector. Particularly, a bandwidth from 1980 MHz to 2010 MHz is allocated for an uplink and a bandwidth from 2170 MHz to 2200 MHz is allocated for a downlink. Therefore, it is very difficult to realize a frequency reuse factor of 3 or 7 because a wireless interface having a minimum bandwidth of 10 MHz is required to provide a broadband service. In practical, a frequency reuse factor of 7 cannot be realized. In order to realize a frequency reuse factor of 3, an entire frequency band has to be allocated to one operator. Therefore, it is essential to realize a mobile satellite communication system having a frequency reuse factor of 1 to provide a broadband service.

In case of a CDMA mobile satellite communication system, a frequency reuse factor of 1 may be realized by using a different spreading code for each beam to reduce interference between adjacent beams. However, in case of an OFDMA mobile satellite communication system which has been considered as a TDMA, FDMA, and IMT_Advanced wireless access technology, it is not easy to realize a frequency reuse factor of 1. Here, CDMA stands for Code Division Multiple Access. Further, OFDMA stands for Orthogonal Frequency-Division Multiple Access, TDMA stands for Time-Division Multiple Access, and FDMA stands for Frequency-Division Multiple Access.

Therefore, there is a demand to develop a method for reducing a performance gap of a satellite communication service between a beam center area and a beam boundary area by realizing a frequency reuse factor of 1 in an OFDMA mobile satellite communication system, improving a frequency use efficiency of a user in a beam boundary area, and minimizing interference between adjacent beams.

### SUMMARY OF THE INVENTION

An embodiment of the present invention is directed to satellite communication method and apparatus for realizing a frequency reuse factor of 1 in an OFDMA mobile satellite communication system.

Another embodiment of the present invention is directed to satellite communication method and apparatus for improving frequency usage efficiency of a user in a beam boundary area and minimizing interference between adjacent beams in a mobile satellite communication system.

Another embodiment of the present invention is directed to satellite communication method and apparatus for improving frequency usage efficiency and a signal to noise ratio by dynamically allocating resources according to traffic requirements of users in a beam boundary area.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a satellite communication method includes detecting a location of a terminal, determining a signal transmission scheme for the terminal using the terminal location, determining a subcarrier region to transmit a signal to the terminal using the location of the terminal, and communicating with the terminal using the determined signal transmission scheme and the determined subcarrier region.

In accordance with an embodiment of the present invention, a satellite communication apparatus of a mobile satellite communication system includes a detector configured to detect a location of a terminal, a first controller configured to determine a signal transmission scheme for the terminal using the location of the terminal, a second controller configured to determine a subcarrier region to transmit a signal to the terminal using the location of the terminal, and a communication unit configured to communicate with the terminal using the signal transmission scheme and the subcarrier region.

### BRIEF DESCRIPTION OF THE DRAWINGS

FIG. 1 is a diagram illustrating beams divided into a beam center area and a beam boundary area using a typical fractional frequency reuse scheme.

FIG. 2 is a diagram illustrating a transmission power of a signal and subcarrier regions divided by a typical method.

FIG. 3 is a diagram illustrating signal transmission periods and subcarrier regions in accordance with a typical satellite communication method.

FIG. 4 is a system using a coordinated multi-point transmission scheme in accordance with an embodiment of the present invention.

FIG. 5 is a diagram illustrating a satellite communication apparatus in accordance with an embodiment of the present invention.

FIG. 6 is a diagram illustrating a multi beam system where each beam includes divided areas.

FIGS. 7A and 7B shows a signal transmission period of a satellite in accordance with an embodiment of the present invention.

FIG. 8 is a diagram illustrating a signal transmission period and a subcarrier area in accordance with an embodiment of the present invention.

FIG. 9 is a diagram illustrating a signal transmission period and a subcarrier region in accordance with another embodiment of the present invention.

FIG. 10 is a diagram illustrating a subcarrier region and a signal transmission period in accordance with another embodiment of the present invention.

FIG. 11 is a flowchart illustrating a satellite communication method in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

The present invention relates to satellite communication method and apparatus for improving a frequency usage efficiency of a beam boundary area by minimizing interference at a beam boundary area using a coordinated multi-point transmission scheme and controlling a subcarrier area allocated to a beam boundary area in a multi-beam mobile satellite communication system such as an Orthogonal Frequency-Division Multiple Access (OFDMA) based mobile satellite communication system using a frequency reuse factor of 1.

At first, a frequency reuse scheme for realizing a frequency reuse factor of 1 in a typical OFDMA based multi-beam mobile satellite communication system and the problems thereof will be described. Then, satellite communication method and apparatus in accordance with embodiments of the present invention will be described in detail thereafter.

Unlike a Code Division Multiple Access (CDMA) mobile communication system, an OFDMA mobile communication system cannot fundamentally use a frequency reuse factor of 1 due to interference between adjacent cells. According, the OFDMA based mobile communication system is less appropriate in a Cellular communication environment in comparison with the CDMA based mobile communication system. In case of a ground network, a fractional frequency reuse scheme is employed to overcome such a defect of the OFDMA mobile communication system. That is, the fractional frequency reuse scheme is employed to realize a frequency reuse factor of 1 in the OFDMA mobile communication system. Through the fractional frequency reuse scheme, the OFDMA mobile communication system can be used in the Cellular environment. The fractional frequency reuse scheme is a method of reducing interference between adjacent cells by dividing one cell into multiple divided areas and allocating a fractional part of a subcarrier to each divided area. However, following assumptions are required to employ the fractional frequency reuse scheme in the ground network. First of all, there is a large difference in a path loss value between a center area near a base station and a boundary area comparatively far from the base station. Secondly, a signal can be divided by divided areas of a cell and transmitted through an antenna of each divided area. Therefore, such a typical fractional frequency reuse scheme of the ground network cannot be applicable to a satellite network where a signal cannot be divided per each divided area. Accordingly, it is necessary to develop a fractional frequency reuse scheme appropriate for a satellite network.

As a fractional reuse scheme appropriate for a satellite network, a typical OFDMA mobile satellite communication system was introduced as follows. In the typical OFDMA mobile satellite communication, a beam is divided into a center area and a boundary area, and a period is divided by time for allocating resources to a user in a beam center area and a user in a beam boundary area. Within a time period for a user in a beam center area, an entire subcarrier of an available frequency band is allowed to use. Within a time period for a user in a beam boundary area, an available frequency band is divided into a plurality of fractional subcarrier regions and a predetermined part of the fractional subcarrier regions is allowed to use in order to avoid interference between adjacent beams. Hereinafter, such a typical OFDMA mobile satellite communication system will be described with the accompanying drawings.

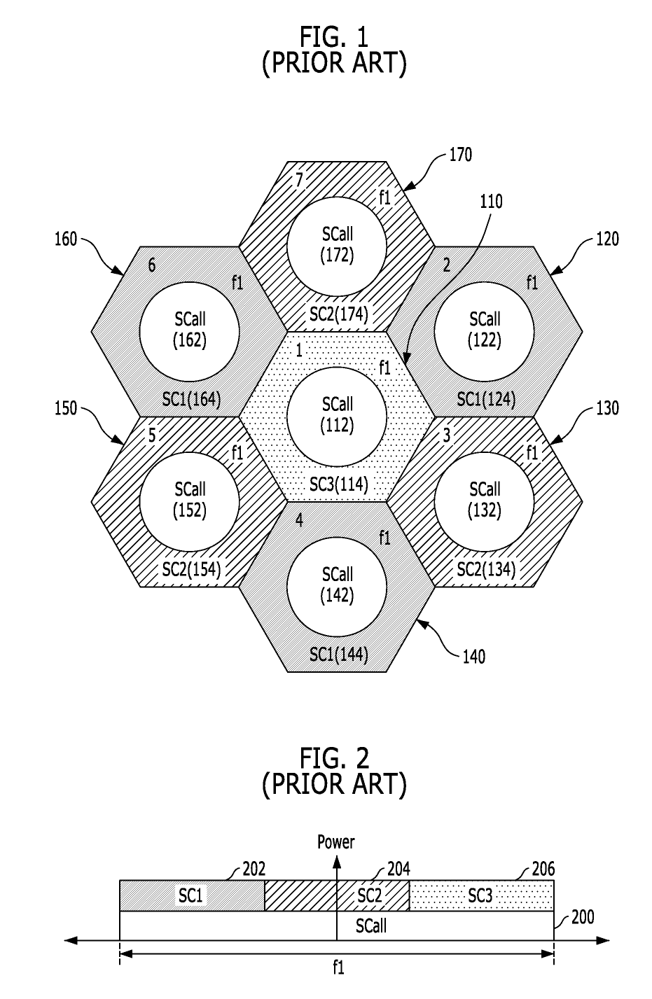

FIG. 1 is a diagram illustrating beams divided into a beam center area and a beam boundary area using a typical fractional frequency reuse scheme.

Referring to FIG. 1, a frequency reuse factor of 1 can be realized because all beams use only a frequency f1. Here, beam boundary areas 114, 124, 144, 154, 164, and 174 are greatly interfered by adjacent beam. In order to reduce such interference, an OFDMA subcarrier region is differently allocated to each beam. Accordingly, in a beam boundary area, a signal is transmitted during a subcarrier region different from that allocated to an adjacent beam boundary area. For instance, a signal is transmitted using an entire subcarrier region SCall in beam center areas 112, 122, 132, 142, 152, 162, and 172. However, in beam boundary areas 114, 124, 134, 144, 154, 164, and 174, the entire subcarrier region is divided into three fractional subcarrier regions SC1, SC2, and SC3, and one of the three regions is used, thereby eliminating interference between adjacent beams.

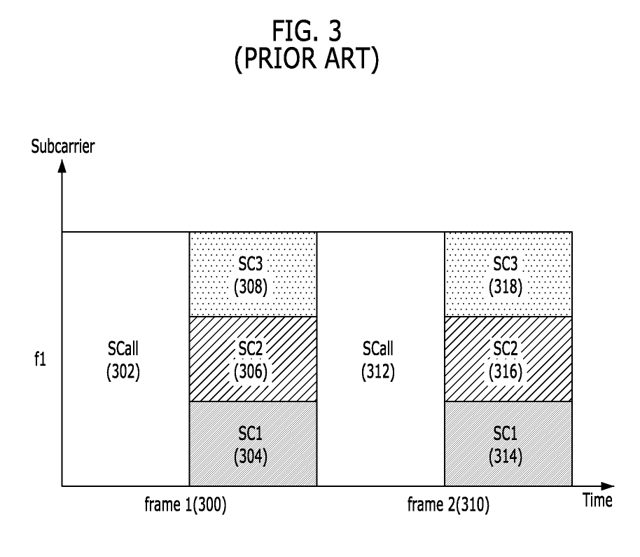

FIG. 2 is a diagram illustrating a transmission power of a signal and subcarrier regions divided by a typical method.

Referring to FIG. 2, f1 denotes a frequency band usable in satellite communication. At a beam center area, an entire frequency band 200 is used as a subcarrier region SCall. At a beam boundary area, the entire subcarrier region SCall is divided into three different fractional subcarrier regions SC1, SC2, and SC3, and one of three subcarrier regions SC1, SC2, and SC3 is used. In general, it is assumed that a power of a signal transmitted from a terminal using the entire subcarrier SCall is identical to a power of a signal transmitted from a terminal using one of fractional subcarrier regions SC1 to SC3. Since power loss in a beam center area is smaller than that in a beam boundary area, interference at a beam boundary area can be reduced by transmitting a signal from a terminal using the entire subcarrier region SCall with smaller power than a signal from a terminal using the fractional subcarrier regions SC1 to SC3.

Referring to FIGS. 1 and 2, a fractional subcarrier region (SC3) 206 is used at a boundary area 114 of a first beam 110. Fractional subcarrier regions (SC1 and SC2) 202 and 204 are alternately used at beam boundary areas 124, 134, 144, 154, 164, and 174 of adjacent six beams 120, 130, 140, 150, 160, and 170. Accordingly, interference can be eliminated in the adjacent boundary areas.

FIG. 3 is a diagram illustrating signal transmission periods and subcarrier regions in accordance with a typical satellite communication method.

In case of a satellite beam, a path loss difference between a beam center area and a beam boundary area is not large. When signals are transmitted simultaneously to terminals using an entire subcarrier SCall and terminals using one of fractional subcarrier regions SC1 to SC3, signals are significantly interfered to each others. Accordingly, a signal transmitted to terminals in a beam center area and terminals in a beam boundary area is timely multiplexed within one frame or multiple frames in order to overcome the interference problem.

FIG. 3 shows a time-multiplexed frame structure for terminals located at a first beam 110, a second beam 120, and a third beam 130. Although FIG. 3 shows a time-multiplexing method that separates terminals using SCall and terminals using SC1 to SC3 within one frame in a time domain, it is possible to apply a multiple-frame based time-multiplexing method that transmits a signal to terminals using the entire subcarrier SCall at a first frame and then transmits a signal to terminals using the fractional subcarriers SC1 to SC3 at a next frame.

In case of using such a typical fractional frequency reuse scheme, maximum frequency usage efficiency of a beam boundary area is dropped to ⅓ compared to that of a beam center area because a user in a beam boundary region uses only one of fractional subcarrier regions SC1 to SC#. Further, a receiving Effective Isotropically Radiated Power (EIRP) from a satellite beam in a beam boundary area is lower than that in a beam center area. Accordingly, overall performance is deteriorated.

The present invention relates to a communication method for increasing a capacity of a beam boundary area in order to overcome such a problem. That is, a Coordinated Multi-point transmission scheme is introduced.

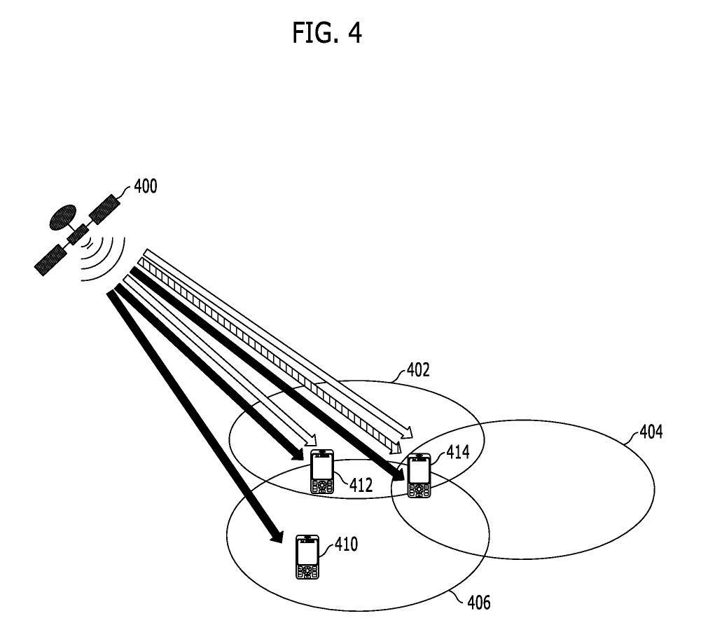

In the coordinated multi-point transmission scheme, beams cooperate with each other to provide a satellite communication service to a user rather than competing to each other. That is, the coordinated multi-point transmission scheme means a multi-beam transmission scheme that enables a signal from an adjacent beam to improve a communication service quality. The coordinated multi-point transmission scheme will be described in detail through FIG. 4.

FIG. 4 is a system using a coordinated multi-point transmission scheme in accordance with an embodiment of the present invention.

In FIG. 4, a satellite 400 transmits a signal to a first terminal 410, a second terminal 412, and a third terminal 414 using a first beam 402, a second beam 404, and a third beam 406.

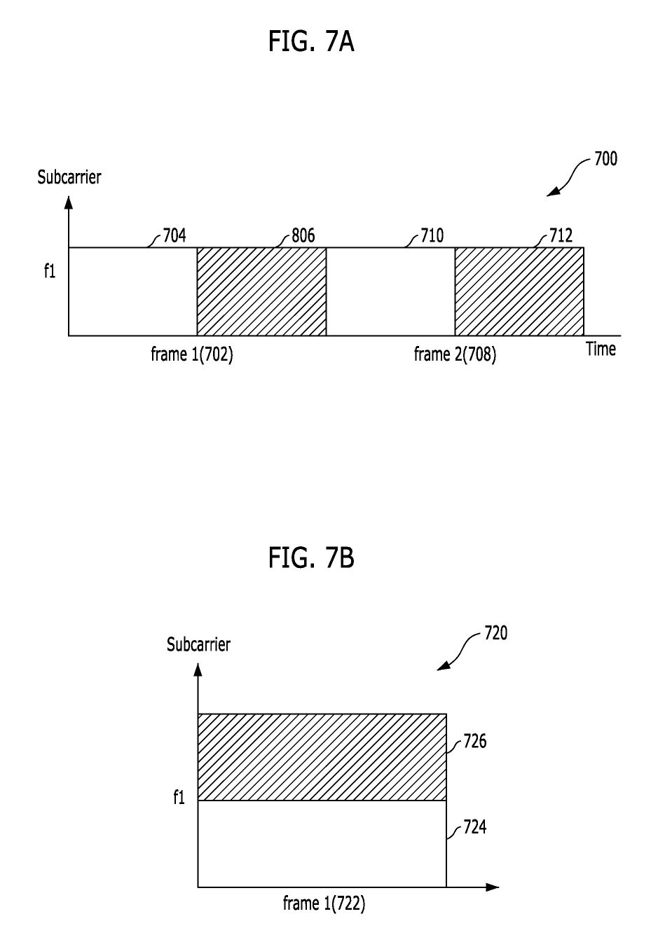

The first terminal 410 is located at a beam center area. A signal is transmitted to the first terminal 410 using an entire subcarrier during a transmission period allocated to the beam center area. A signal is not transmitted to the second terminal 412 and the third terminal 414 during the transmission period allocated to the beam center area because it could interfere a user in the beam center area. A method for allocating different transmission periods to a beam center area and a beam boundary area will be described with reference to FIGS. 7A to 10 in later. In a typical method, users in a beam boundary area use different resources at adjacent beams to receive a communication service from one of adjacent beams. Unlike the typical method, a user in a beam boundary area receives a signal through all available beams in the coordinated multi-point transmission method in accordance with an embodiment of the present invention. For example, in the typical method, the second terminal 412 receives a signal only from the first beam 402, and a signal from the third beam 406 causes interference. In the coordinated multi-point transmission method in accordance with an embodiment of the present invention, the signal from the third beam 406 does not causes interference. The signal from the third beam 406 enhances the signal from the firs beam 402. Similarly, the first beam 402, the second beam 404, and the third beam 406 cooperate with each other to transmit a signal to the third terminal 414 through the same resource. Accordingly, a reception performance of the third terminal 414 is improved.

Accordingly, the satellite communication method and apparatus according to the embodiment of the present invention can improve a signal to noise ratio because a user receives a signal from adjacent multiple beams although the user is located at a beam boundary area. Further, interference can be avoided because an adjacent beam also transmits an own signal. If many users are located at a predetermined boundary area, the embodiment of the present invention can allocate a large subcarrier region to the users at the predetermined boundary area. Accordingly, the maximum frequency usage efficiency can be improved. It will be described in later.

However, the number of users provided with a communication service may be reduced because adjacent beams have to cooperate with each other to communicate with only one user in the coordinated multi-point transmission method in accordance with an embodiment of the present invention. For example, if the third beam 406 does not use resources for the second terminal 412, it is possible to communicate with other users in a boundary area of the third beam 406. However, such a possibility can be overcome through proper managements of resources and frequencies between multi beams and through increment of capacity in a beam boundary area.

Hereinafter, a satellite communication method in a mobile satellite communication system and an apparatus thereof in accordance with an embodiment of the present invention will be described with the accompanying drawings.

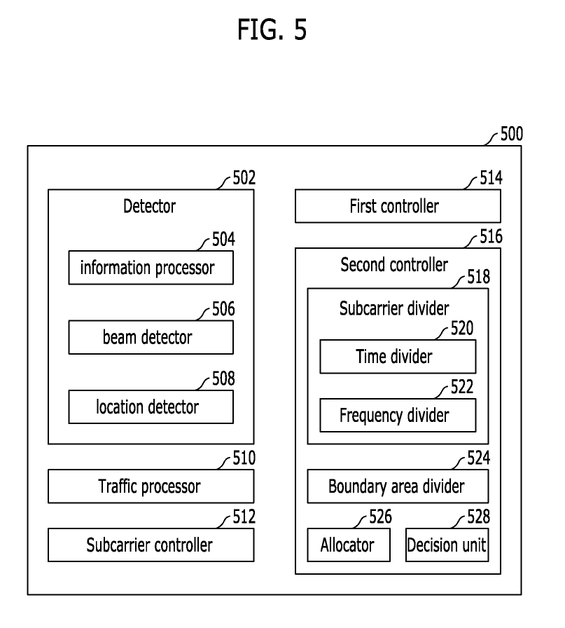

FIG. 5 is a diagram illustrating a satellite communication apparatus in accordance with an embodiment of the present invention.

Referring to FIG. 5, a satellite communication apparatus in accordance with an embodiment of the present invention includes a detector 502, a traffic processor 510, a subcarrier controller 512, a first controller 514, and a second controller 516. The detector 502 includes an information processor 504, a beam detector 506, and a location detector 508. The second controller 504 includes a subcarrier divider 518, a boundary area divider 524, an allocator 526, and a decision unit 528. The subcarrier divider 518 includes a time divider 520 and a frequency divider 522.

The detector 502 detects a location of a terminal in multiple beams. Since locations of multiple beams and terminals are changed in real time in a mobile satellite communication system, a location of a terminal is relatively determined according to the movement of a satellite or according to the movement of a terminal user.

The information processor 504 obtains location information about a location of a terminal. The location information includes information about a beam where a predetermined terminal belongs to and information about a location of the predetermined terminal in the beam. In order to obtain the location information, a satellite may directly receive location information from a terminal or a satellite may dynamically trace a location of the terminal.

The beam detector 506 detects a beam where a predetermined terminal is located at from multiple beams based on the location information obtained from the information processor 504.

The location detector 508 detects a location of a terminal in a beam. In the embodiment of the present invention, one beam can be divided into a beam center area and a beam boundary area. The beam boundary area may be divided again into a two-beam adjacent boundary area and a three-beam adjacent boundary area. The location detector 508 determines where a terminal is located at among the divided areas.

The first controller 514 determines a signal transmission scheme for a terminal using the detected terminal location from the detector 502. When a terminal is located at a beam center area, the first controller 514 determines a single-point transmission scheme as the signal transmission scheme. The single-point transmission scheme transmits a signal using only the beam of the beam center area. When a terminal is located at a beam boundary area, the first controller 514 determines a coordinated multi-point transmission scheme that use beams adjacent to the beam boundary area to transmit a signal. For instance, if a terminal is located at a two beam adjacent area, the first controller determines a coordinated multi-point transmission scheme using adjacent two beams. If a terminal is located at a three beam adjacent area, the first controller determines a coordinated multi-point transmission scheme using adjacent three beams.

The second controller 516 determines a subcarrier region to transmit a signal to a terminal using the detected terminal location from the detector 502.

At first, the subcarrier divider 518 divides an entire subcarrier region into at least two fractional subcarrier regions. The subcarrier region may be a limited frequency band or a predetermined time period that a satellite can use. Such division can be performed by the time divider 520 in a time domain or by the frequency divider 522 in a frequency domain. Alternately, such division can be performed by the time divider 520 and the frequency divider 522 in a time domain and a frequency domain at the same time. A method of dividing a subcarrier region will be described in detail with reference to FIG. 7A to FIG. 10.

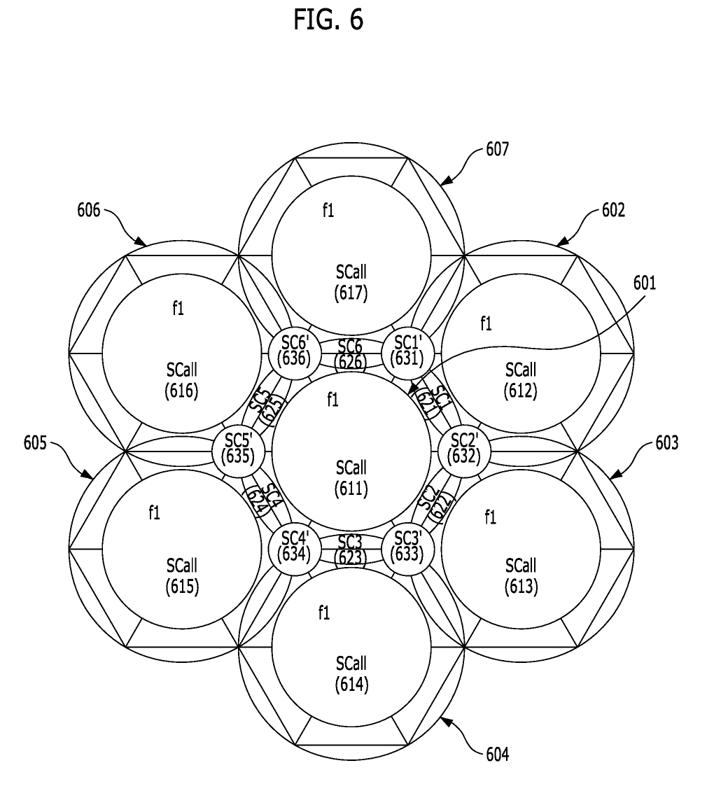

The boundary area divider 524 divides a beam boundary area into at least two different boundary areas based on relation with adjacent beams in order to allocate the divided subcarrier regions to a predetermined area of a beam. Considering a general multi-beam satellite system where each beam has a hexagonal shape, a beam boundary area can be divided into six two-beam adjacent boundary areas and six three-beam adjacent boundary areas. It will be described with reference to FIG. 6 in later.

The allocator 526 allocates the divided subcarrier regions from the subcarrier divider 518 to a beam center area and beam boundary areas divided by the boundary area divider 524.

The decision unit 528 decides a subcarrier region allocated to a terminal area as a subcarrier region to be used by the terminal.

The traffic processor 510 calculates a total required traffic amount of terminals located at beam boundary areas. As a method for improving a usage efficiency of limited frequency, the traffic processor 510 calculates a total required traffic amount by inspecting a required traffic amount of all terminals located at beam boundary areas and controls a size of a subcarrier region to be allocated to a predetermine area according to a ratio of required traffic amounts of terminals located at each boundary area.

The subcarrier controller 512 controls a size of a subcarrier region allocated to each boundary area according to the ratio of required traffic amounts of terminals located at each boundary area, which is calculated from the traffic processor 510. The second controller 516 allocates different subcarrier regions to each boundary area based on the controlled size of the subcarrier region from the subcarrier controller 512. Since a further larger subcarrier can be allocated to an area having many users in the present embodiment, it is possible to solve a problem of a typical fractional frequency reuse scheme such as the decrement of frequency efficiency.

FIG. 6 is a diagram illustrating a multi beam system where each beam includes divided areas.

FIG. 6 illustrates a multi-beam system formed of one beam 601 and six adjacent beams 602 to 607. In the multi-beam system of FIG. 6, a signal is transmitted using the same frequency band f1 from all beams by realizing a frequency reuse factor of 1. All beams are divided into a beam center area and a beam boundary area. In case of a beam 601 located at a center of the multi-beam system of FIG. 6, the beam boundary area of the beam 601 is divided into six two-beam boundary adjacent areas 621 to 626 and six three-beam adjacent boundary areas 631 to 636. In the center areas 611 to 617, the entire subcarrier area SCall can be used. In the boundary areas 621 to 626 and 631 to 636, divided subcarrier regions SC1 to SC6 and SC1′ to SC6′ allocated to each divided are can be used.

FIGS. 7A and 7B shows a signal transmission period of a satellite in accordance with an embodiment of the present invention.

In the embodiment of the present invention, a transmission period can be divided for a beam center area user and a beam boundary area user without reducing capacity of a beam center area.

Referring to FIG. 7A, one frame 702 of a transmission period is divided in a time domain into a period 704 for a beam center area user and a period 706 for a beam boundary area user as shown in a graph 700. Further, one frame 722 of a transmission period may be divided in a frequency domain into a period 724 and a period 726. Then, the period 724 may be allocated for a center area user and the period 726 may be allocated for a boundary area user.

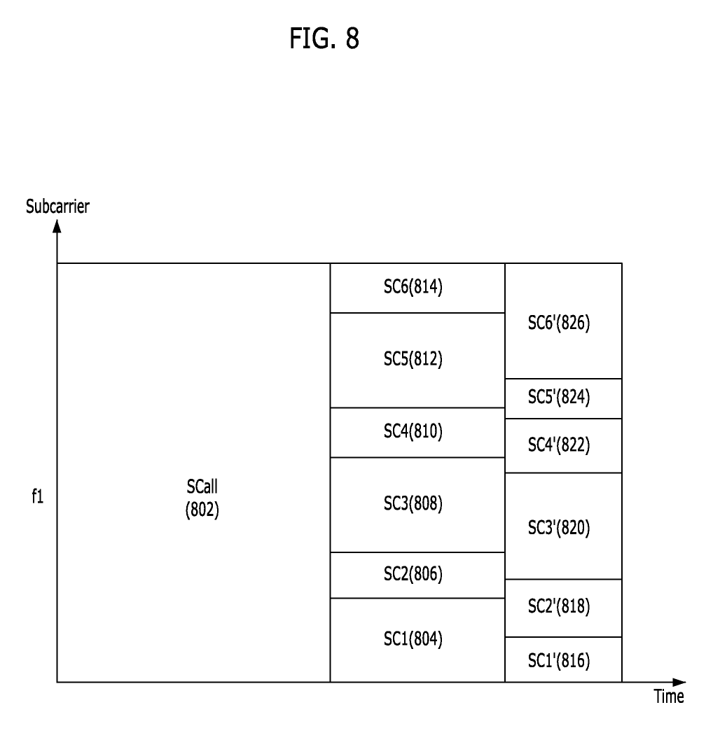

FIG. 8 is a diagram illustrating a signal transmission period and a subcarrier area in accordance with an embodiment of the present invention.

Referring to FIG. 8, one frame is divided into three transmission periods in a time domain. The first transmission period is allocated to a beam center area user. The second transmission period is allocated to a two-beam adjacent boundary area user. The third transmission period is allocated to a three-beam adjacent boundary area. Referring to FIG. 6, the second transmission period corresponds to a case that six different subcarrier regions SC1 to SC6, which are divided in a frequency domain, are allocated to six two-beam adjacent boundary areas 621 to 626. The third transmission period corresponds to a case that six different subcarrier regions SC1′ to SC6′, which are divided in a frequency domain, are allocated to six three-beam adjacent boundary areas. Here, a size of a subcarrier region allocated to each area is different. As shown, a size of a subcarrier region can be dynamically controlled according to a required traffic amount and a service requirement of a terminal located at each area in order to improve frequency usage efficiency. For example, when a beam boundary area 621 includes a lot of users to communicate compared to other areas or a user of the area 621 requires high speed data communication, it is possible to enlarge a size of a subcarrier region SC1 to be allocated thereto.

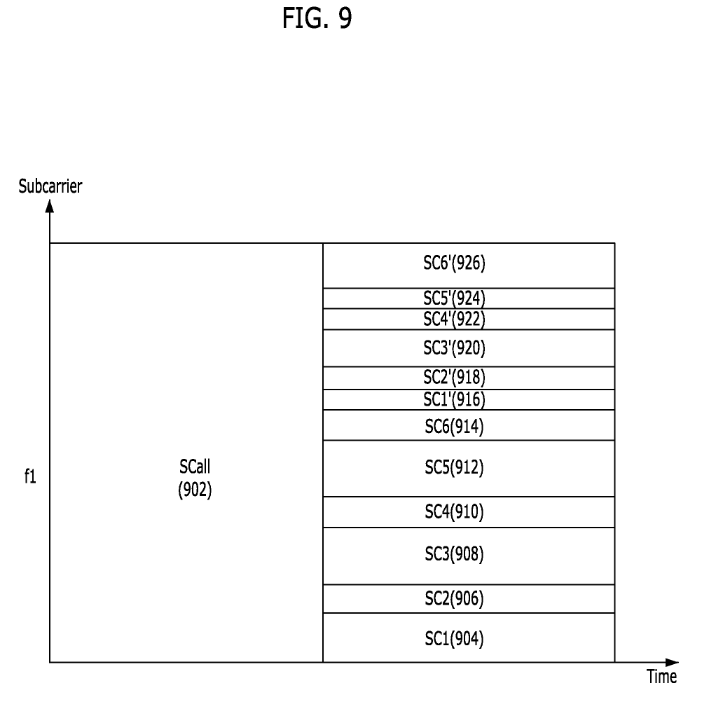

FIG. 9 is a diagram illustrating a signal transmission period and a subcarrier region in accordance with another embodiment of the present invention.

Referring to FIG. 9, one frame is divided into two transmission periods in a time domain. A first transmission period is allocated to a beam center area user, and a second transmission period is allocated to a beam boundary area user. The second transmission period corresponds to that twelve different subcarrier regions SC1 to SC6 and SC1′ to SC6′, which are divided in a frequency domain, are allocated to twelve boundary areas 621 to 626 and 631 to 636 as shown in FIG. 6. As shown in FIG. 8, a size of a subcarrier region may be dynamically controlled according to a required traffic amount and a service requirement of a terminal located at each area in order to improve frequency usage efficiency.

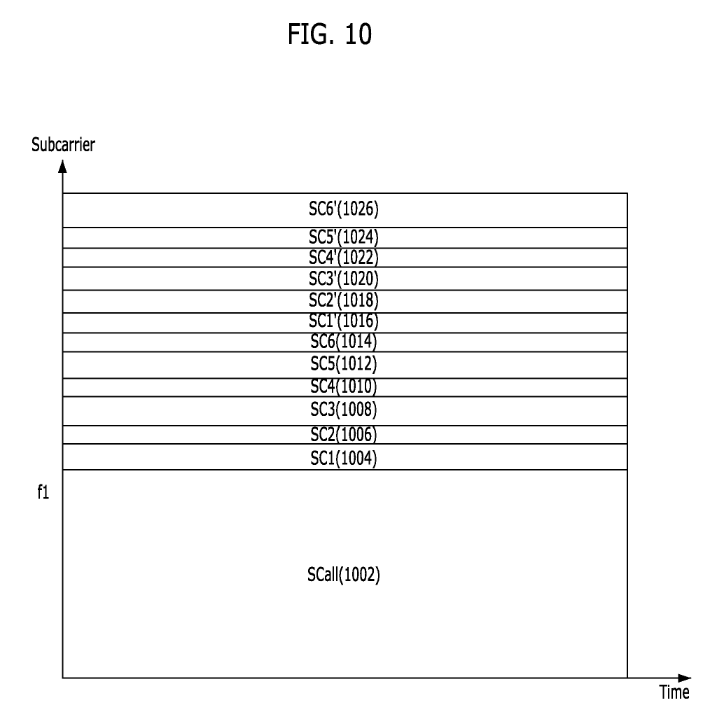

FIG. 10 is a diagram illustrating a subcarrier region and a signal transmission period in accordance with another embodiment of the present invention.

As shown in FIG. 10, a signal transmission period may be divided in a frequency domain and the divided periods may be allocated. A SCall region 1002 is allocated to a center area user, and remaining regions SC1 to SC6 and SC1′ to SC6′ are allocated to each boundary area user.

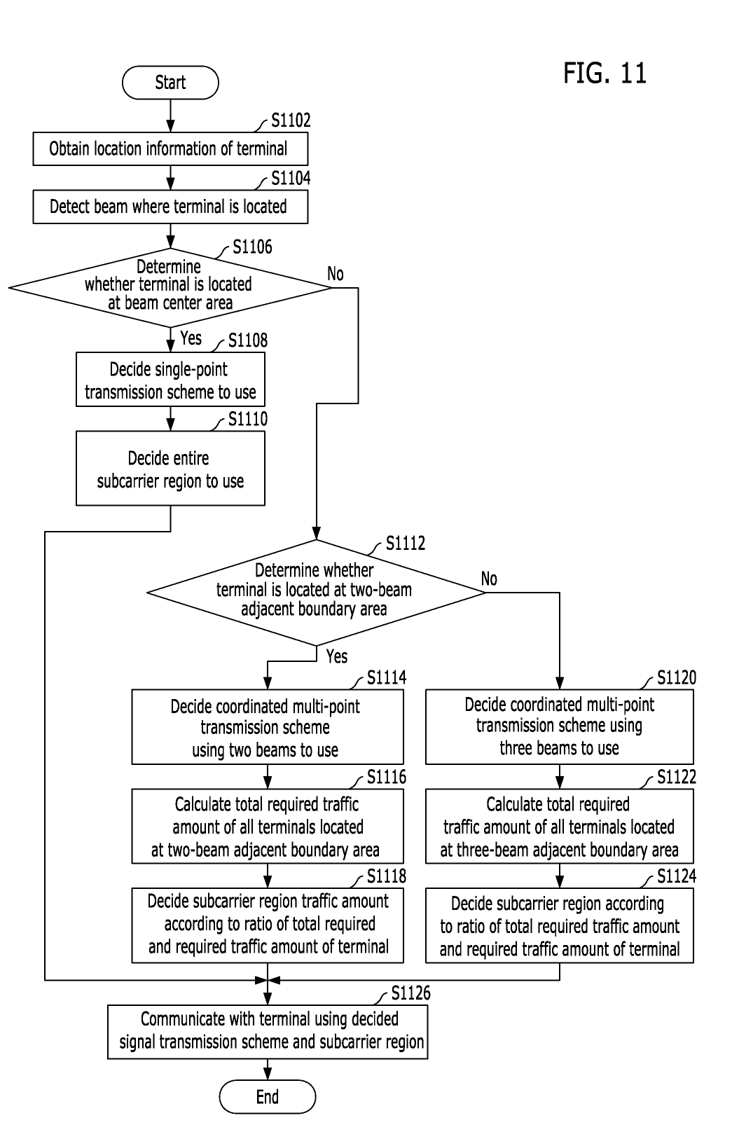

FIG. 11 is a flowchart illustrating a satellite communication method in accordance with an embodiment of the present invention.

At step S1102, a satellite obtains location information of a terminal. At step S1104, a beam where a terminal is located at is detected. At step S1106, a terminal location is determined whether a terminal is located at a beam center area or beam boundary areas.

When a terminal is located at the beam center area, a single point transmission scheme is decided as a signal transmission scheme at step S1108, and overall subcarrier areas are decided to use at step S1110.

When a terminal is located at the beam boundary area, it is determined whether a terminal is located at a two-beam adjacent boundary area or a three-beam adjacent boundary area at step S1112. When the terminal is located at the two-beam adjacent boundary area, a coordinated multi-point transmission scheme using two beams is decided as a transmission scheme at step S1114. At step S1116, a total required traffic amount of all terminals in the two-beam adjacent boundary area. At step S1118, a size of a subcarrier region to be allocated to a corresponding area is decided according to a ratio of a required traffic amount of a terminal and a total required traffic amount.

When a terminal is located at a three-beam adjacent boundary area, a coordinated multi-point transmission scheme using three beams is determined as a signal transmission scheme at step S1120. At step S1122, a total required traffic amount of all terminals located at the three-beam adjacent boundary area is calculated. At step S1122, a size of a subcarrier region to be allocated to a corresponding area is decided according to a ratio of a required traffic amount of a terminal and a total required traffic amount.

At S1126, a satellite communicates with a terminal using the decided signal transmission scheme and subcarrier region after the step S1110, the step S1118, or the step S1124.

As described above, the satellite communication method and apparatus in accordance with an embodiment of the present invention can realize a frequency reuse factor of 1 in an OFDMA based mobile satellite communication system.

The satellite communication method and apparatus in accordance with an embodiment of the present invention can improve a frequency usage efficiency of a user in a beam boundary area and minimize interference between adjacent beams in a mobile satellite communication system.

The satellite communication method and apparatus in accordance with an embodiment of the present invention can increase frequency usage efficiency and a signal to noise ratio by dynamically allocating resources according to traffic requirements of users in a beam boundary area.

While the present invention has been described with respect to the specific embodiments, it will be apparent to those skilled in the art that various changes and modifications may be made without departing from the spirit and scope of the invention as defined in the following claims.

What is claimed is:

1. A satellite communication method in a mobile satellite communication system, comprising:
detecting a location of a terminal;
determining a signal transmission scheme for the terminal using the terminal location;
determining a subcarrier region to transmit a signal to the terminal using the location of the terminal; and
communicating with the terminal using the determined signal transmission scheme and the determined subcarrier region.

2. The satellite communication method of claim 1, wherein said detecting a location of a terminal includes:
obtaining location information of the terminal;
detecting a beam where the terminal is located at using the obtained location information; and
determining whether the terminal is located at a beam center area or a beam boundary area of the beam.

3. The satellite communication method of claim 2, wherein said determining a signal transmission scheme includes:
deciding a signal-point transmission scheme using the beam as the signal transmission scheme when the terminal is located at the beam center area of the beam.

4. The satellite communication method of claim 2, wherein said determining a signal transmission scheme includes:
deciding a coordinated multi-point transmission scheme using the beam and beams adjacent to the beam boundary area as the signal transmission scheme when the terminal is located at the beam boundary area of the beam.

5. The satellite communication method of claim 2, wherein said determining a subcarrier region includes:
dividing an entire subcarrier region into at least two fractional subcarrier regions;
dividing the beam boundary area into at least two different beam boundary areas;
allocating the entire subcarrier area to the beam center area and allocating the at least two fractional subcarrier regions to the at least two different beam boundary areas; and
determining a subcarrier region allocated to an area where the terminal is located at as the subcarrier region.

6. The satellite communication method of claim 5, wherein the entire subcarrier region is divided into six different fractional subcarrier regions, and the beam boundary area is divided into six two-beam adjacent boundary areas and six three-beam adjacent boundary areas.

7. The satellite communication method of claim 6, wherein said allocating the at least two fractional subcarrier regions to the at least two different beam boundary areas includes:
allocating the six fractional subcarrier regions to the six two-beam adjacent boundary areas, respectively.

8. The satellite communication method of claim 6, wherein said allocating the at least two fractional subcarrier regions to the at least two different beam boundary areas includes:
allocating the six fractional subcarrier regions to the six three-beam adjacent boundary areas, respectively.

9. The satellite communication method of claim 5, wherein the entire subcarrier region is divided into twelve fractional subcarrier regions, and the beam boundary area is divided into six two-beam adjacent boundary areas and six three-beam adjacent boundary areas.

10. The satellite communication method of claim 9, wherein said allocating the at least two fractional subcarrier regions to the at least two different beam boundary areas includes:
allocating the twelve fractional subcarrier regions to the six two-beam adjacent boundary areas and the six three-beam adjacent boundary areas, respectively.

11. The satellite communication method of claim 5, wherein in said dividing the entire subcarrier region into at least two fractional subcarrier regions,
the entire subcarrier region is divided in a time domain, divided in a frequency domain, or divided in a time domain and a frequency domain at the same time.

12. The satellite communication method of claim 2, further comprising:
calculating a total required traffic amount of terminals located at the beam boundary area; and
controlling a size of the determined subcarrier region according to a ratio of the total required traffic amount and a required traffic amount of each terminal.

13. A satellite communication apparatus of a mobile satellite communication system, comprising:
a detector configured to detect a location of a terminal;
a first controller configured to determine a signal transmission scheme for the terminal using the location of the terminal;
a second controller configured to determine a subcarrier region to transmit a signal to the terminal using the location of the terminal; and
a communication unit configured to communicate with the terminal using the signal transmission scheme and the subcarrier region.

14. The satellite communication apparatus of claim 13, wherein the detector includes:
an information processor configured to obtain location information of the terminal;
a beam detector configured to detect a beam where the terminal is located at using the obtained location information; and
an area detector configured to determine whether the terminal is located at a beam center area and a beam boundary area of the beam.

15. The satellite communication apparatus of claim 14, wherein the first controller decides a single-point transmission scheme using the beam as the signal transmission scheme when the terminal is located at the beam center area, and
the first controller decides a coordinated multi-point transmission scheme using the beam and beams adjacent to the beam boundary area as the signal transmission scheme when the terminal is located at the beam boundary area.

16. The satellite communication apparatus of claim 14, wherein the second controller includes:
a subcarrier divider configured to divide an entire subcarrier region into at least two fractional subcarrier regions;
a beam boundary area divider configured to divide the beam boundary area into at least two different boundary areas;
an allocator configured to allocate the entire subcarrier region to the beam center area and allocating the at least two fractional subcarrier regions to the at least two different boundary areas; and
a decider configured to decide a subcarrier region allocated to an area where the terminal is located at as the subcarrier region.

17. The satellite communication apparatus of claim 16, wherein the subcarrier divider includes:
a time divider configured to divide the entire subcarrier region in a time domain; and
a frequency divider configured to divide the entire subcarrier region in a frequency domain.

18. The satellite communication apparatus of claim 14, further comprising:
a traffic processor configured to calculate a total required traffic amount of terminals located at the beam boundary area; and
a subcarrier controller configured to control a size of the determined subcarrier region according to a ratio of the total required traffic amount and a required traffic amount of each terminal.
